(19) United States
(12) Patent Application Publication
(10) Pub. No.: US 2025/0298336 A1
(43) Pub. Date: Sep. 25, 2025

(54) STATIC ELIMINATION DEVICE AND IMAGE FORMING APPARATUS

(71) Applicant: FUJIFILM Business Innovation Corp., Tokyo (JP)

(72) Inventor: Shinji KAWASHIMA, Kanagawa (JP)

(73) Assignee: FUJIFILM Business Innovation Corp., Tokyo (JP)

(21) Appl. No.: 18/770,590

(22) Filed: Jul. 11, 2024

(30) Foreign Application Priority Data
Mar. 25, 2024 (JP) 2024-048750

(51) Int. Cl. G03G 15/02; G03G 21/20

(52) U.S. Cl. CPC G03G 15/0291; G03G 21/206

(57) ABSTRACT

A static elimination device includes a corona discharge electrode that faces a recording medium to be transported and extends in a cross direction intersecting a transport direction of the recording medium, an airflow generation device that causes a gas around the corona discharge electrode to flow toward the recording medium, and a suction duct that is disposed on an upstream side or a downstream side of the corona discharge electrode in the transport direction, extends in the cross direction, and sucks in the gas flowing on the recording medium by the airflow generation device.

### CROSS-REFERENCE TO RELATED APPLICATIONS

This application is based on and claims priority under 35 USC 119 from Japanese Patent Application No. 2024-048750 filed Mar. 25, 2024.

### BACKGROUND

### (i) Technical Field

The present invention relates to a static elimination device and an image forming apparatus.

### (ii) Related Art

A static elimination device disclosed in JP2019-167169A includes a contact type state elimination unit that has a state elimination member which comes into contact with a charged medium to be transported, and that eliminates a majority amount of charges with which the charged medium is charged, and a non-contact type state elimination unit that is provided on a downstream side in a transport direction of the charged medium with respect to the contact type state elimination unit and that eliminates the residual charges of the charged medium after the charge is eliminated by the contact type state elimination unit, in a non-contact state.

### SUMMARY

Aspects of non-limiting embodiments of the present disclosure relate to a static elimination device and an image forming apparatus that restrain ozone-containing gas, which is generated in a central portion of a corona discharge electrode extending in a cross direction intersecting a transport direction of a recording medium, from stagnating on a surface of the recording medium as compared with a case where the ozone-containing gas is discharged only from both ends of the recording medium in the cross direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a static elimination device including a corona discharge electrode that faces a recording medium to be transported and extends in a cross direction intersecting a transport direction of the recording medium, an airflow generation device that causes a gas around the corona discharge electrode to flow toward the recording medium, and a suction duct that is disposed on an upstream side or a downstream side of the corona discharge electrode in the transport direction, extends in the cross direction, and sucks in the gas flowing on the recording medium by the airflow generation device.

### BRIEF DESCRIPTION OF THE DRAWINGS

Exemplary embodiment(s) of the present invention will be described in detail based on the following figures, wherein:

FIG. 1 is a schematic configuration diagram showing an image forming apparatus according to a first exemplary embodiment of the present disclosure;

FIG. 2 is a schematic configuration diagram showing a toner image forming unit of the image forming apparatus according to the first exemplary embodiment of the present disclosure;

FIG. 3 is a perspective view showing a chain gripper of the image forming apparatus according to the first exemplary embodiment of the present disclosure;

FIG. 4 is a perspective view showing a secondary transfer roll and the like of a transfer device according to the first exemplary embodiment of the present disclosure;

FIG. 5 is a perspective view showing a heating roll, a pressing roll, and the like of the image forming apparatus according to the first exemplary embodiment of the present disclosure;

FIG. 6 is a cross-sectional view showing the heating roll, the pressing roll, and the like of the image forming apparatus according to the exemplary embodiment of the present disclosure;

FIG. 7 is an overall perspective view showing a static elimination device according to the first exemplary embodiment of the present disclosure;

FIG. 8 is a cross-sectional view of the static elimination device according to the first exemplary embodiment of the present disclosure, which is taken along a plane orthogonal to a depth direction;

FIG. 9 is an enlarged perspective view showing a corotron provided in the static elimination device according to the first exemplary embodiment of the present disclosure;

FIG. 10 is a cross-sectional view of the static elimination device according to the first exemplary embodiment of the present disclosure, which is taken along a plane orthogonal to an up-down direction;

FIGS. 11A and 11B are perspective views showing a discharge port of a discharge duct and a suction port of a suction duct in the static elimination device according to the first exemplary embodiment of the present disclosure;

FIG. 12 is a front view showing a static elimination device according to a comparative exemplary embodiment with respect to the first exemplary embodiment of the present disclosure; and

FIG. 13 is a cross-sectional view of a static elimination device according to a second exemplary embodiment of the present disclosure, which is taken along a plane orthogonal to a depth direction.

### DETAILED DESCRIPTION

### First Exemplary Embodiment

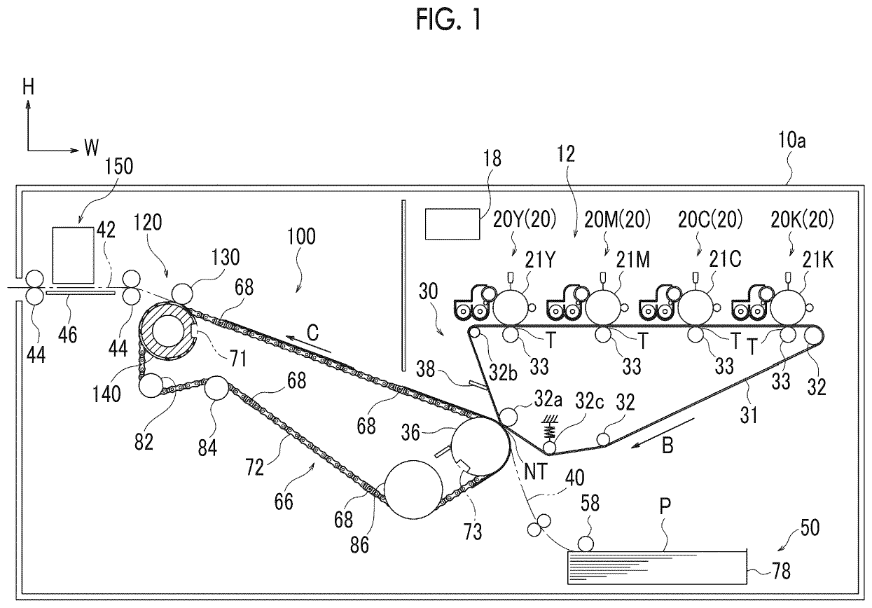

An example of a static elimination device and an image forming apparatus according to a first exemplary embodiment of the present disclosure will be described with reference to FIGS. 1 to 12. An arrow H shown in each drawing indicates an apparatus up-down direction, which is a vertical direction, an arrow W indicates an apparatus width direction, which is orthogonal to the arrow H and is a horizontal direction, and an arrow D indicates an apparatus depth direction, which is orthogonal to the arrows H and W and is a horizontal direction.

An image forming apparatus 10 according to the present exemplary embodiment is an electrophotographic image forming apparatus that forms a toner image on a sheet member P as a recording medium. As shown in FIG. 1, the image forming apparatus 10 includes an accommodation section 50, an image forming section 12, and a control unit 18 that controls each unit.

### Accommodation Section 50

As shown in FIG. 1, the accommodation section 50 includes a loading portion 78 to which the sheet member P is loaded and a feeding roll 58 that feeds, to a supply path 40, the uppermost sheet member P loaded on the loading portion 78.

### Image Forming Section 12

As shown in FIG. 1, the image forming section 12 is disposed above the accommodation section 50. The image forming section 12 includes a toner image forming unit 20 that forms a toner image, a transfer device 30 that transfers the toner image formed by the toner image forming unit 20 to the sheet member P, a fixing device 100 that fixes the toner image onto the sheet member P, and a static elimination device 150 that eliminates static electricity with which the sheet member P is charged.

### Toner Image Forming Unit 20

As shown in FIG. 1, a plurality of the toner image forming units 20 are provided to form toner images for respective colors. The image forming section 12 includes the toner image forming units 20 for a total of four colors of yellow (Y), magenta (M), cyan (C), and black (K). (Y), (M), (C), and (K) shown in FIG. 1 indicate constituent portions corresponding to the respective colors.

A toner image forming unit 20Y, a toner image forming unit 20M, a toner image forming unit 20C, and a toner image forming unit 20K are basically configured in the same manner except for toner to be used.

As shown in FIG. 1, the toner image forming units 20Y, 20M, 20C, and 20K are arranged along a horizontal portion of a transfer belt 31 provided in the transfer device 30. In the following description, the toner image forming units 20Y, 20M, 20C, and 20K will be described without alphabets letters at the ends in a case where the toner image forming units 20Y, 20M, 20C, and 20K are not to be particularly distinguished from each other.

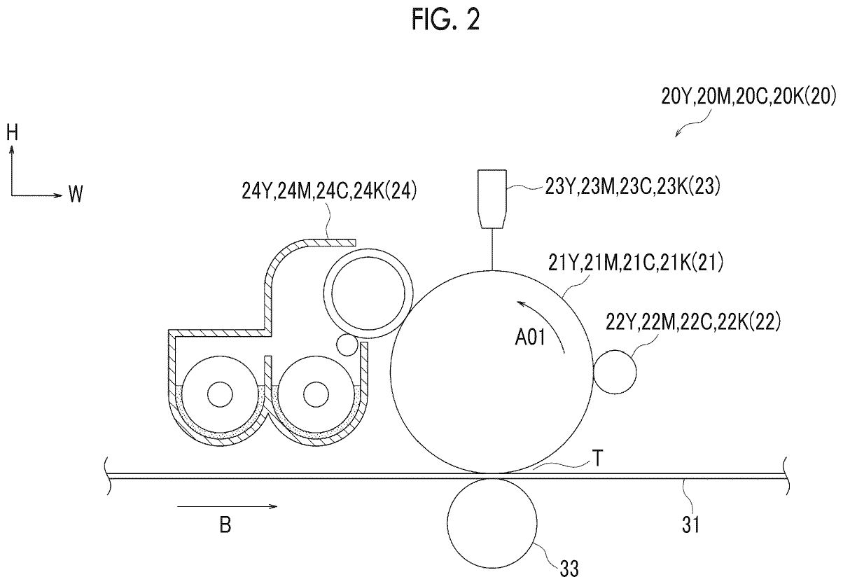

As shown in FIG. 2, the toner image forming unit 20 includes an image holding body 21 that rotates in a direction along an arrow A01 in the drawing and a charger 22 that charges the image holding body 21. Furthermore, the toner image forming unit 20 includes an exposure device 23 that forms an electrostatic latent image by exposing the image holding body 21 charged by the charger 22 to light, and a development device 24 that forms a toner image by developing the electrostatic latent image by using toner.

### Transfer Device 30

As shown in FIG. 1, the transfer device 30 includes the transfer belt 31 as an intermediate transfer body, a plurality of rolls 32, primary transfer rolls 33, a transfer cylinder 36, and a scraping member 38.

The transfer belt 31 has an endless shape and is wound around the plurality of rolls 32 such that the transfer belt 31 has an inverted triangular shape. The toner image forming units 20Y, 20M, 20C, and 20K are arranged along the horizontal portion of the transfer belt 31 that is on an upper side. The transfer belt 31 revolves in a direction along an arrow B as at least one of the plurality of rolls 32 is rotationally driven.

In addition, in the following description, among the plurality of rolls 32, the roll 32 disposed to push out an inclined portion of the transfer belt 31 that is on one side in the width direction (left side in the drawing) will be referred to as a roll 32a, and the roll 32 around which a portion of the transfer belt 31 that is on the one side in the width direction is wound will be referred to as a roll 32b. Furthermore, the roll 32 that is disposed on an upstream side of the roll 32a in a revolution direction of the transfer belt 31 will be referred to as a roll 32c.

The roll 32b functions as a drive roll that is rotationally driven with a drive force applied from a drive source 34. In addition, the roll 32c functions as a tensile force applying roll that presses the transfer belt 31 from an inner surface of the transfer belt 31 and that applies a tensile force to the transfer belt 31.

The primary transfer rolls 33 are disposed on an opposite side of the image holding bodies 21 of the respective colors with the transfer belt 31 interposed therebetween. In addition, the primary transfer rolls 33 transfer, to the transfer belt 31, toner images formed on the image holding bodies 21 at primary transfer positions T between the image holding bodies 21 and the primary transfer rolls 33.

The transfer cylinder 36 is disposed on an opposite side of the roll 32a with the transfer belt 31 interposed therebetween and is rotationally driven. In addition, the transfer cylinder 36 transfers, to the sheet member P, the toner images transferred to the transfer belt 31 at a secondary transfer position NT between the transfer belt 31 and the transfer cylinder 36.

The scraping member 38 is disposed between the roll 32a and the roll 32b in the revolution direction of the transfer belt 31, and scrapes off an attachment adhering to a surface of the transfer belt 31 from the transfer belt 31.

### Fixing Device 100

As shown in FIG. 1, the fixing device 100 includes a chain gripper 66 and a main heating section 120 that comes into contact with the sheet member P to heat the toner image.

### Chain Gripper 66

The chain gripper 66 includes a pair of chains 72, leading end holding portions 68 each of which holds a leading end of the sheet member P, and sprockets 71, 73, 82, 84, and 86.

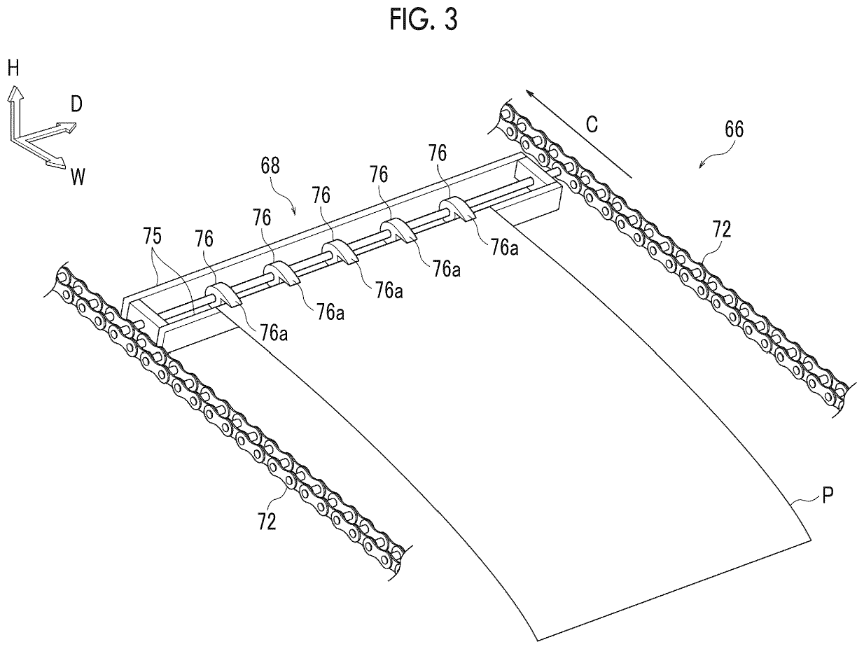

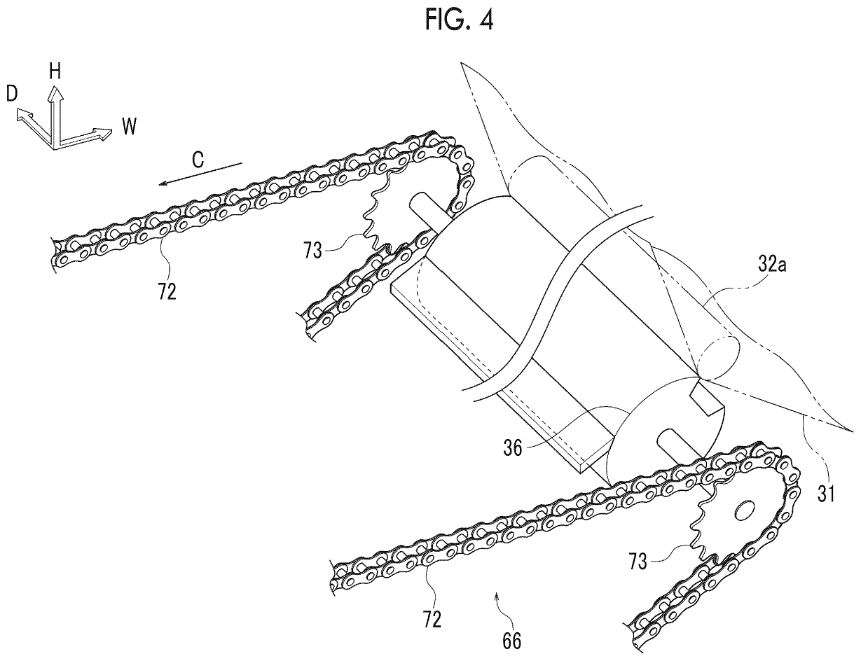

As shown in FIG. 3, the pair of chains 72 are disposed spaced apart from each other in the depth direction, and each of the chains 72 is formed in an endless shape. As shown in FIG. 4, the pair of chains 72 are wound around a pair of the sprockets 73 that are disposed on both end sides in an axial direction of the transfer cylinder 36 and of which an axial direction is parallel to the depth direction.

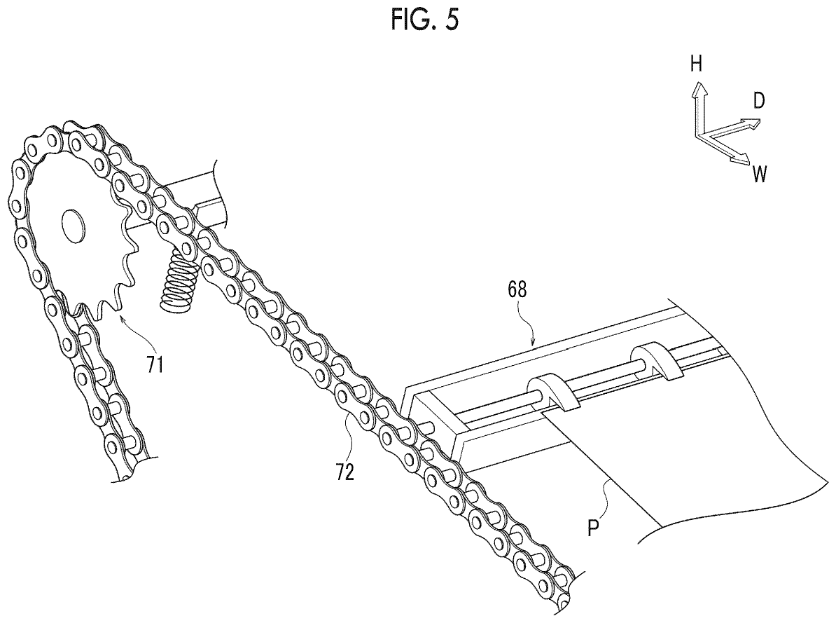

In addition, the pair of chains 72 are wound around a pair of the sprockets 71 (see FIG. 5) that are disposed on one end side and the other end side in an axial direction of a pressing cylinder 140, which will be described below, and of which an axial direction is parallel to the depth direction. Furthermore, the pair of chains 72 are wound around a pair of the sprockets 82, a pair of the sprockets 84, and a pair of the sprockets 86, the sprockets of each pair being disposed at an interval in the depth direction.

In addition, as shown in FIG. 1, the sprockets 71 that are disposed on both end sides of the pressing cylinder 140 are disposed on the one side (left side in the drawing) in the width direction and on the upper side with respect to the sprockets 73 disposed on both end sides of the transfer cylinder 36.

In addition, as viewed in the depth direction, the pair of sprockets 82 are disposed on a lower side with respect to the sprockets 71. Furthermore, the pair of sprockets 86 are disposed on the lower side with respect to the sprockets 73 and 82, are disposed on the one side in the width direction with respect to the sprockets 73, and are disposed on the other side in the width direction with respect to the sprockets 82. In addition, the pair of sprockets 84 are disposed to lift portions of the chains 72 that are between the sprockets 82 and the sprockets 86 from the lower side to the upper side.

As shown in FIG. 3, each of the leading end holding portions 68 includes an attachment member 75 that extends in the depth direction, and grippers 76 attached to the attachment member 75, and both side portions of the leading end holding portion 68 in the depth direction are attached to the pair of chains 72, respectively.

A plurality of the leading end holding portions 68 are provided and are disposed at predetermined intervals in a circumferential direction (revolution direction) of the chains 72 (see FIG. 1).

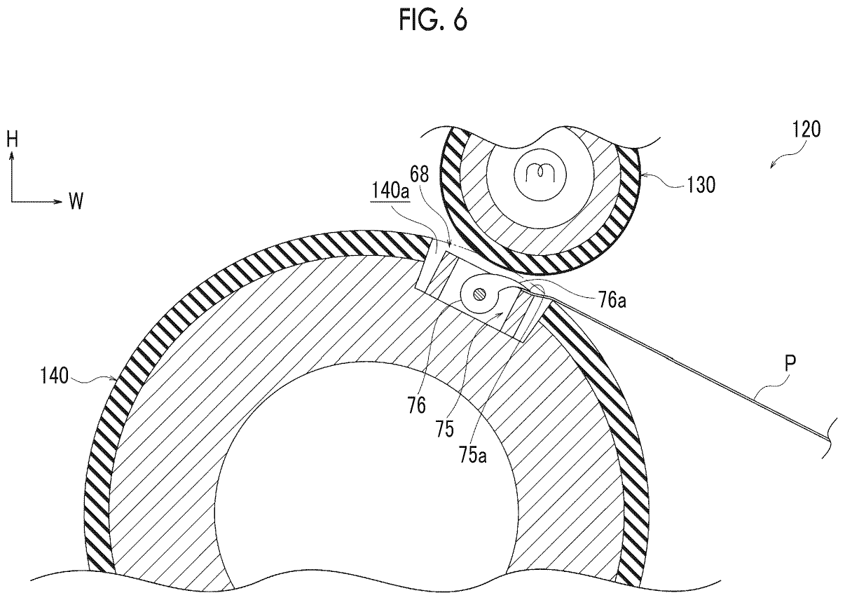

A plurality of the grippers 76 are provided and are attached to the attachment member 75 at predetermined intervals in the depth direction. Each gripper 76 has a function of holding the leading end of the sheet member P. Specifically, the grippers 76 includes claws 76a. In addition, a contact portion 75a (see FIG. 6) with which the claws 76a come into contact is formed at the attachment member 75.

The grippers 76 are configured to hold the sheet member P with the leading end of the sheet member P being pinched between the claws 76a and the contact portion 75a. Regarding the grippers 76, for example, the claws 76a are pressed against the contact portion 75a by a spring or the like and the claws 76a are brought into contact with and separated from the contact portion 75a by the effect of a cam or the like.

In this configuration, a rotational force is transmitted to the sprockets 71 and 73 out of the plurality of sprockets 71, 73, 82, 84, and 86 shown in FIG. 1, so that the pair of chains 72 revolve in a direction along an arrow C in the drawing.

Furthermore, in a case where the leading end holding portion 68 attached to the pair of chains 72 reaches the sprockets 73, the grippers 76 of the leading end holding portion 68 hold and receive the sheet member P transported along the supply path 40 by pinching the leading end of the sheet member P. Then, the chains 72 revolving in the direction along the arrow C transport the sheet member P held by the leading end holding portion 68 toward the secondary transfer position NT. Furthermore, the revolving chains 72 transport the sheet member P toward the main heating section 120. In addition, at a position where the leading end of the sheet member P passes through the main heating section 120, the leading end holding portion 68 releases the holding of the leading end of the sheet member P, and the chain gripper 66 feeds the sheet member P to a discharge path 42. Then, the sheet member P fed to the discharge path 42 is discharged to an outside of an apparatus body 10a.

### Main Heating Section 120

As shown in FIG. 1, the main heating section 120 is disposed on a downstream side of the secondary transfer position NT in a transport direction of the sheet member P (hereinafter, referred to as a “sheet transport direction”). In addition, the main heating section 120 includes a heating roll 130 that comes into contact with the sheet member P being transported and that heats the sheet member P, and the pressing cylinder 140 that presses the sheet member P toward the heating roll 130.

In this configuration, the pressing cylinder 140 presses the sheet member P toward the heating roll 130. Furthermore, the pressing cylinder 140 is rotated with a rotational force transmitted from a drive member (not shown). In addition, the heating roll 130 rotates in response to the rotation of the pressing cylinder 140. Furthermore, the heating roll 130 and the pressing cylinder 140 transport the sheet member P, to which a toner image has been transferred, with the sheet member P sandwiched therebetween, so that the toner image is heated and fixed onto the sheet member P.

### Static Elimination Device 150

As shown in FIG. 1, the static elimination device 150 is disposed in the discharge path 42 on the downstream side of the fixing device 100 in the transport direction of the sheet member P. Specifically, a pair of discharge rolls 44 arranged in the width direction are provided in the discharge path 42, and the static elimination device 150 is disposed between the pair of discharge rolls 44. The discharge roll 44 is an example of a transport section. Details of the static elimination device 150 will be described below.

### Effect of Image Forming Apparatus

In the image forming apparatus 10 shown in FIG. 1, a toner image is formed on the sheet member P as follows. First, the chargers 22 for the respective colors shown in FIG. 2 uniformly and negatively charge surfaces of the image holding bodies 21 of the respective colors at a predetermined potential. Subsequently, based on image data input from the outside, the exposure devices 23 irradiate the charged surfaces of the image holding bodies 21 of the respective colors with exposure light to form electrostatic latent images.

As a result, the electrostatic latent images corresponding to the image data are formed on the respective surfaces of the image holding bodies 21. Furthermore, the development devices 24 of the respective colors develop the electrostatic latent images, and visualize the electrostatic latent images as toner images. In addition, the primary transfer rolls 33 of the transfer device 30 shown in FIG. 1 transfer, to the transfer belt 31, the toner images formed on the surfaces of the image holding bodies 21 of the respective colors at the primary transfer positions T.

Therefore, the sheet member P fed from the accommodation section 50 to the supply path 40 by the feeding roll 58 is delivered to the leading end holding portion 68 (see FIG. 3) of the chain gripper 66 and is transported. The sheet member P transported by the chain gripper 66 is fed toward the secondary transfer position NT. At the secondary transfer position NT, the sheet member P is transported while being sandwiched between the transfer belt 31 and the transfer cylinder 36, so that the toner images on the surface of the transfer belt 31 are transferred onto a surface of the sheet member P.

Furthermore, the fixing device 100 fixes, onto the sheet member P, the toner images transferred onto the surface of the sheet member P, and the sheet member P transported by the chain gripper 66 is fed to the discharge path 42. The sheet member P fed to the discharge path 42 is discharged to the outside of the apparatus body 10a.

### Major Configuration

Next, the static elimination device 150 will be described.

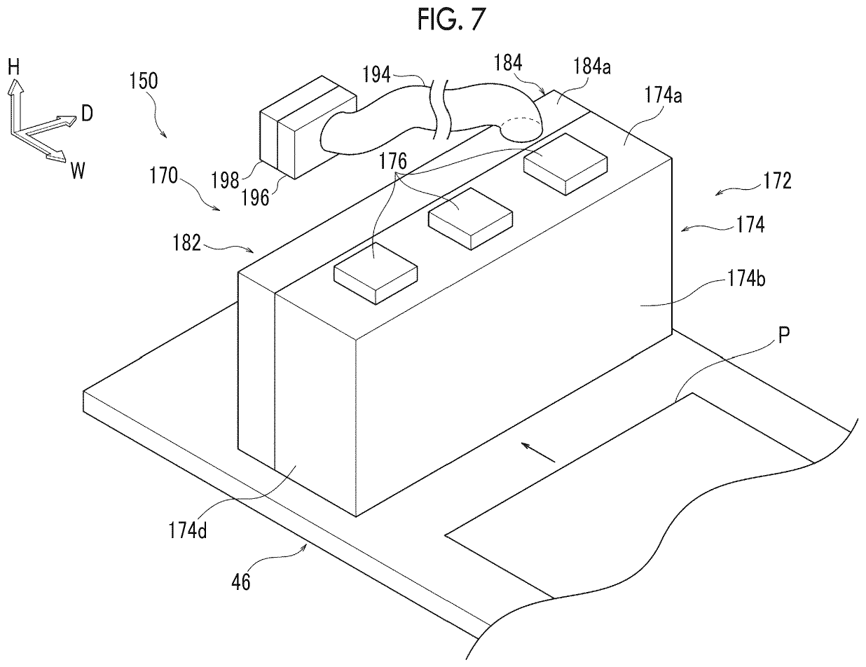

As shown in FIGS. 1 and 7, the static elimination device 150 is disposed on an opposite side of a paper guide 46, which is provided along the discharge path 42 through which the sheet member P is discharged, with the discharge path 42 interposed therebetween. Specifically, the paper guide 46 is disposed below the discharge path 42, and the static elimination device 150 is disposed above the discharge path 42.

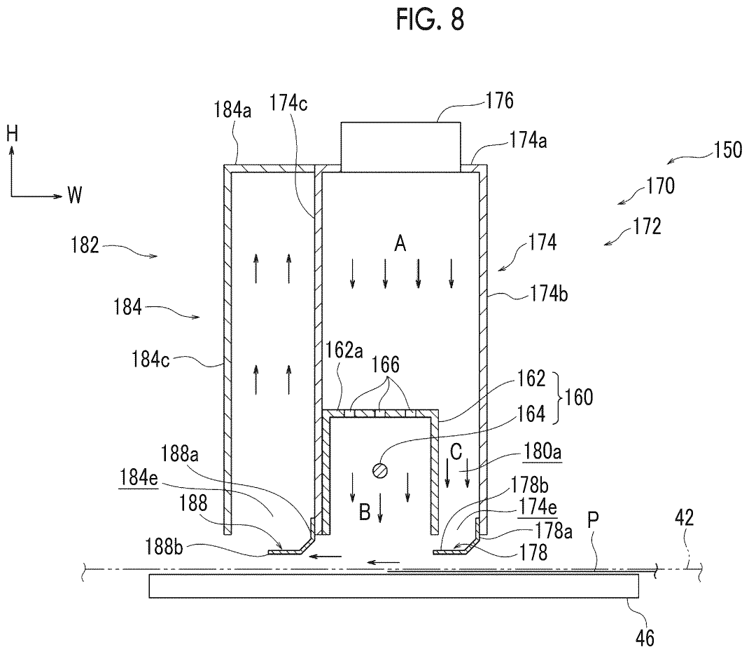

The static elimination device 150 has a rectangular parallelepiped shape extending in the depth direction. As shown in FIG. 8, the static elimination device 150 includes a corotron 160 that eliminates static electricity of the charged sheet member P through corona discharge, and a recovery unit 170 that recovers ozone generated through the corona discharge.

### Corotron 160

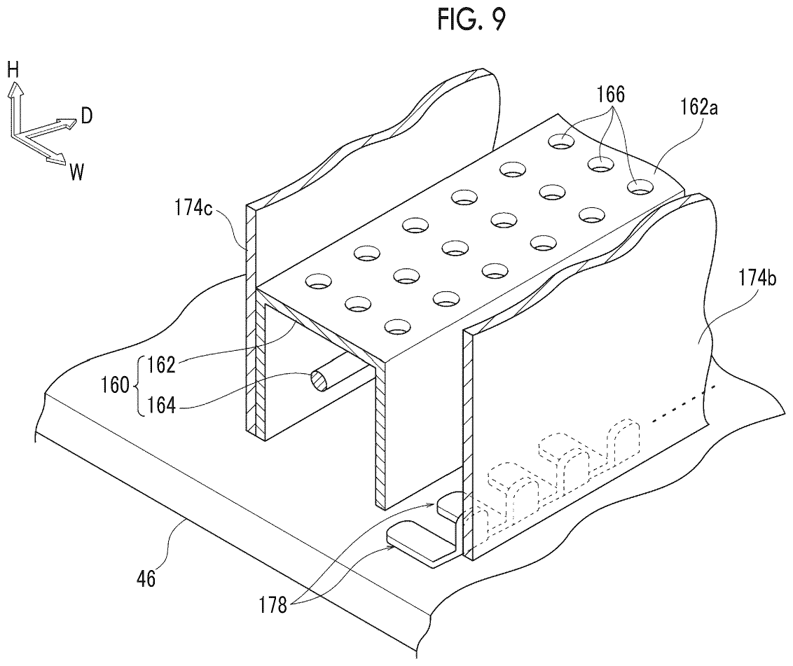

As shown in FIG. 8, the corotron 160 includes a shield case 162 which is a housing, and a discharge wire 164 which is a discharge electrode to which a voltage is applied. The shield case 162 is made of stainless steel, has a box shape that is open to the discharge path 42 side, and extends in the depth direction. In addition, as shown in FIG. 9, a plurality of through-holes 166 having a circular shape are formed in a bottom plate 162a of the box-shaped shield case 162 such that the through-holes 166 are arranged vertically and horizontally. The corotron 160 is an example of a corona discharge electrode.

The discharge wire 164 is formed of a metal wire such as tungsten, and is disposed in the shield case 102 and extends in the depth direction. Both ends of the discharge wire 164 are respectively attached to a pair of side walls (not shown) of the shield case 162, the side walls having wall surfaces facing the depth direction.

In this configuration, the corona discharge is generated by applying a voltage from a power source (not shown) to the discharge wire 164, so that the charged static electricity of the sheet member P is eliminated. The corona discharge also generates ozone.

### Recovery Unit 170

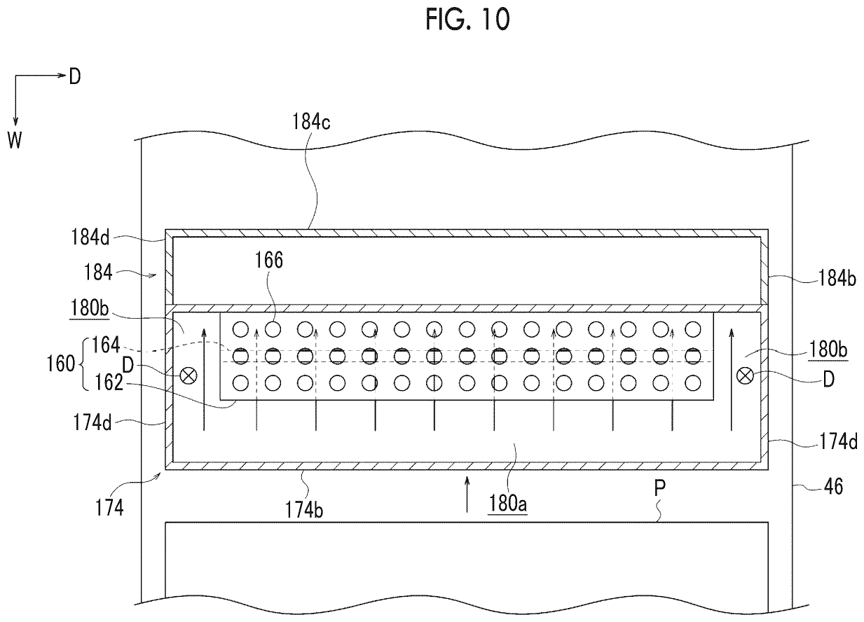

As shown in FIGS. 8 and 10, the recovery unit 170 is provided to cover the corotron 160 from both sides in the width direction, both sides in the depth direction, and the upper side in the up-down direction.

The recovery unit 170 includes a discharge portion 172 that discharges air toward the sheet member P being transported along the discharge path 42, and a suction portion 182 that sucks in the air discharged toward the sheet member P. The air is an example of a gas.

### Discharge Portion 172

As shown in FIG. 8, the discharge portion 172 includes a discharge duct 174, and a fan 176 that causes air to flow (discharges air) toward the sheet member P being transported, through the discharge duct 174. Furthermore, the discharge portion 172 includes a guide portion 178 provided at a discharge port 174e of the discharge duct 174.

The discharge duct 174 has a box shape that is open to the discharge path 42 side, and extends in the depth direction. The discharge duct 174 includes a ceiling plate 174a whose plate thickness direction is the up-down direction, a front plate 174b whose plate thickness direction is the width direction, and a back plate 174c whose plate thickness direction is the width direction and which is disposed on the downstream side of the front plate 174b in the sheet transport direction. Furthermore, as shown in FIG. 10, the discharge duct 174 includes a pair of side plates 174d whose plate thickness direction is the depth direction.

The corotron 160 is disposed inside the discharge duct 174. Specifically, as shown in FIG. 8, the corotron 160 is disposed at an opening portion of the discharge duct 174 with a gap 180a provided between the corotron 160 and the front plate 174b as viewed in the depth direction. Furthermore, as shown in FIG. 10, the corotron 160 is disposed with gaps 180b provided between the corotron 160 and the pair of side plates 174d as viewed in the up-down direction. In other words, on both sides of the corotron 160 in the depth direction, the gaps 180b are formed between the corotron 160 and the pair of side plates 174d. Furthermore, in other words, in the depth direction, the discharge duct 174 protrudes from the corotron 160.

As shown in FIG. 7, a plurality of the fans 176 are attached to the ceiling plate 174a and are arranged side by side in the depth direction. As shown by an arrow in FIG. 8, the fan 176 causes air to flow (discharges air) toward the sheet member P being transported, through the discharge duct 174. The fan 176 is an example of an airflow generation device.

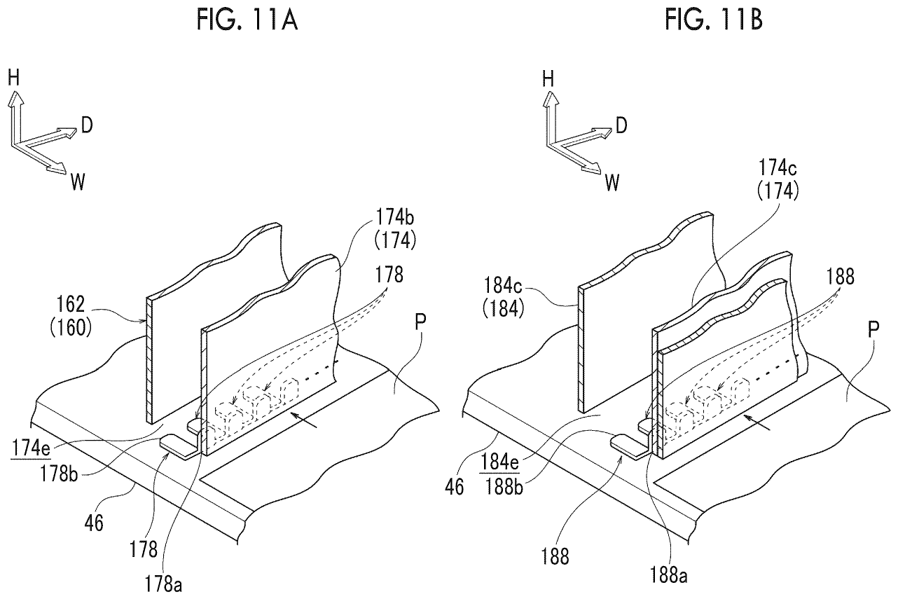

As shown in FIGS. 8 and 11A, a plurality of the guide portions 178 are provided at the discharge port 174e of the discharge duct 174 at intervals in the depth direction. The guide portion 178 is plate-shaped, and an end portion 178a of the guide portion 178 that is on the upstream side in the sheet transport direction is located above an end portion 178b on the downstream side in the sheet transport direction. Furthermore, the end portion 178b is located below a lower end of the shield case 162.

In this configuration, the operating fan 176 causes the air inside the discharge duct 174 to flow toward the sheet member P (see an arrow A in FIG. 8). Here, the air flowing toward the sheet member P is divided into three paths and then discharged toward the sheet member P.

In a first path, the air flowing in a direction of the arrow A passes through the through-holes 166 formed in the bottom plate 162a of the shield case 162, flows into the shield case 162, and is discharged to the sheet member P side (see an arrow B in FIG. 8). In other words, the air with a high ozone concentration around the discharge wire 164 is discharged to the sheet member P side. As a result, the ozone generated through the corona discharge is discharged to the sheet member P side.

In a second path, the air flowing in the direction of the arrow A flows through the gap 180a between the corotron 160 and the front plate 174b and is discharged to the sheet member P side (see an arrow C in FIG. 8). In other words, the air flowing in the direction of the arrow A is discharged from the discharge port 174e of the discharge duct 174 to the sheet member P side (see the arrow C in FIG. 8). Here, a flow passage area of the discharge duct 174 and an area and the number of the through-holes 166 formed in the bottom plate 162a of the shield case 162 are determined such that a flow velocity of the air discharged from the discharge port 174e to the sheet member P side is faster than a flow velocity of the air flowing inside the shield case 162.

In a third path, the air flowing in the direction of the arrow A flows through the gaps 180b formed on both sides of the corotron 160 in the depth direction and is discharged to the sheet member P side (see an arrow D in FIG. 10). As described above, the air inside the discharge duct 174 flows through the first to third paths and is discharged to the sheet member P side.

### Suction Portion 182

As shown in FIG. 8, the suction portion 182 includes a suction duct 184 and a guide portion 188 provided at a suction port 184e of the suction duct 184.

The suction duct 184 has a box shape that is open to the discharge path 42 side, and extends in the depth direction. The suction duct 184 is disposed on the downstream side of the discharge duct 174 in the sheet transport direction. The suction duct 184 includes a ceiling plate 184a whose plate thickness direction is the up-down direction, the back plate 174c of the discharge duct 174, and a back plate 184c whose plate thickness direction is the width direction and which is disposed on the downstream side of the back plate 174c in the sheet transport direction. Furthermore, as shown in FIG. 10, the suction duct 184 includes a pair of side plates 184d whose plate thickness direction is the depth direction. As described above, the back plate 174c is a member that constitutes the discharge duct 174 and is also a member that constitutes the suction duct 184.

As shown in FIGS. 8 and 11B, a plurality of the guide portions 188 are provided at the suction port 184e of the suction duct 184 at intervals in the depth direction. The guide portion 188 is plate-shaped, and an end portion 188a of the guide portion 188 that is on the upstream side in the sheet transport direction is located above an end portion 188b on the downstream side in the sheet transport direction. Furthermore, the end portion 188b is located below a lower end of the back plate 184c.

In addition, as shown in FIG. 1, one end of a discharge duct 194 is connected to the ceiling plate 184a of the suction duct 184, and a discharge fan 196 and an ozone filter 198 are provided in the other end portion of the discharge duct 194.

In this configuration, the air discharged from the discharge duct 174 shown in FIG. 8 to the sheet member P side through the first to third paths described above flows to the downstream side in the sheet transport direction and is sucked into the suction duct 184 and is exhausted.

### Effect of Major Configuration

Next, the effect of the static elimination device 150 will be described together with a static elimination device 250 according to a comparative exemplary embodiment. First, a configuration of the static elimination device 250 according to the comparative exemplary embodiment will be described largely focusing on differences from the static elimination device 150 according to the present exemplary embodiment.

### Configuration of Static Elimination Device 250

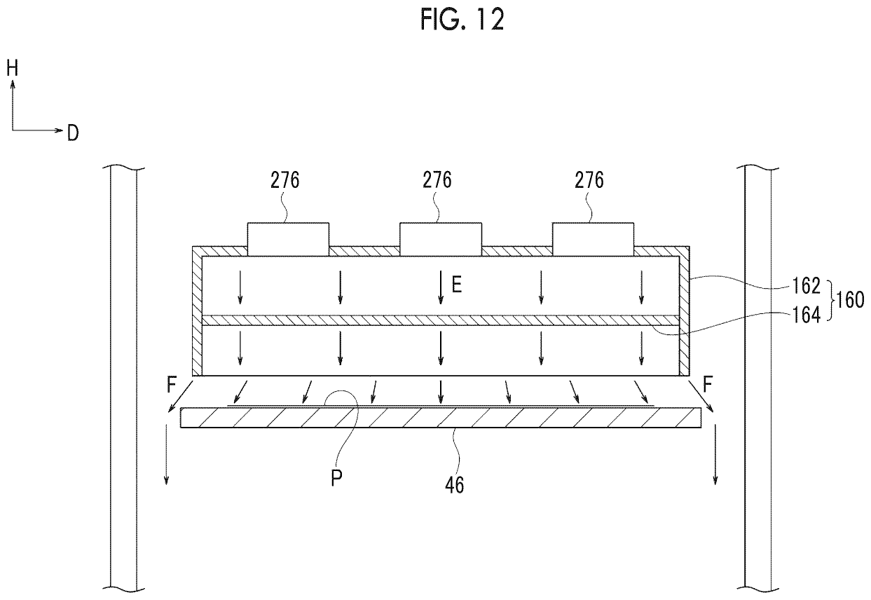

As shown in FIG. 12, the static elimination device 250 according to the comparative exemplary embodiment includes the corotron 160, and a fan 276 that is attached to a through-hole (symbol omitted) formed in the bottom plate 162a of the shield case 162 of the corotron 160 and that causes air to flow (discharges air) toward the sheet member P through the inside of the shield case 162.

### Effect of Static Elimination Device 150 or 250

As shown in FIG. 1, the sheet member P being transported inside the image forming apparatus 10 is charged with static electricity at a secondary transfer position NT to which the toner image is transferred. The sheet member P charged with static electricity is transported along the discharge path 42 and faces the static elimination device 150 or 250.

Corona discharge is generated by applying a voltage to the discharge wire 164 of the corotron 160 of the static elimination device 150 or 250. As a result, the static electricity with which the sheet member P is charged is eliminated. Here, the corona discharge also generates ozone.

### Static Elimination Device 250

In the static elimination device 250 according to the comparative exemplary embodiment, as shown in FIG. 12, the operating fan 276 causes the air inside the shield case 162 to flow toward the sheet member P (see an arrow E in FIG. 12). As a result, air containing the ozone generated through the corona discharge is discharged to the sheet member P side.

At both side portions in the depth direction, the air flowing toward the sheet member P passes outside the paper guide 46 in the depth direction, flows below the paper guide 46, and is discharged (an arrow F in FIG. 12).

On the other hand, in a central portion in the depth direction, the air flowing toward the sheet member P hits the sheet member P and stagnates on the surface of the sheet member P.

### Static Elimination Device 150

In the static elimination device 150 according to the present exemplary embodiment, as shown in FIG. 8, the operating fan 176 causes the air inside the discharge duct 174 to flow toward the sheet member P (see the arrow A in FIG. 8).

The air flowing in the first path after flowing in the direction of the arrow A passes through the through-holes 166 formed in the bottom plate 162a of the shield case 162, flows into the shield case 162, and is discharged to the sheet member P side (see the arrow B in FIG. 8). As a result, air containing the ozone generated through the corona discharge is discharged to the sheet member P side.

Furthermore, the air flowing in the second path after flowing in the direction of the arrow A is discharged from the discharge port 174e of the discharge duct 174 to the sheet member P side (see the arrow C in FIG. 8).

In addition, the air flowing in the third path after flowing in the direction of the arrow A flows through the gaps 180b formed on both sides of the corotron 160 in the depth direction and is discharged to the sheet member P side (see the arrow D in FIG. 10).

The air containing ozone discharged from the inside of the discharge duct 174 to the sheet member P side through the first to third paths flows to the downstream side in the sheet transport direction and is sucked into the suction duct 184 and is exhausted.

As described above, in the static elimination device 150 according to the present exemplary embodiment, unlike the static elimination device 250 according to the comparative exemplary embodiment, the air including the ozone generated in the central portion of the corotron 160 extending in the depth direction is restrained from stagnating on the surface of the sheet member P.

### SUMMARY

As described above, in the static elimination device 150, the air flowing toward the sheet member P by the operating fan 176 flows into the shield case 162 through the through-holes 166 formed in the bottom plate 162a of the shield case 162 and is discharged to the sheet member P side. Furthermore, the air discharged to the sheet member P side flows to the downstream side in the sheet transport direction and is sucked into the suction duct 184 and is exhausted. As a result, the air including the ozone generated in the central portion of the corotron 160 extending in the depth direction is restrained from stagnating on the surface of the sheet member P as compared with a case where the static elimination device 250 according to the comparative exemplary embodiment is used.

In addition, in the static elimination device 150, air containing the ozone generated through the corona discharge is discharged to the sheet member P side, and the discharged ozone-containing air flows to the downstream side in the transport direction and is sucked into the suction duct 184. As a result, an increase in a transport resistance applied to the sheet member P is restrained as compared with a case where the air discharged to the sheet member P side flows to the upstream side in the transport direction and is sucked into the suction duct.

In addition, in the static elimination device 150, the air containing the ozone generated through the corona discharge is discharged to the sheet member P side, and the discharged ozone-containing air is restrained from flowing to the upstream side in the transport direction by the air discharged to the sheet member P side from the discharge port 174e of the discharge duct 174. As a result, the sheet member P being transported is restrained from being damaged by hitting a resin plate as compared with a case where the resin plate is used to restrain the flow of the air to the upstream side.

In addition, in the static elimination device 150, the air flowing toward the sheet member P by the operating fan 176 flows through a flow passage in which the air is discharged toward the sheet member P through the through-holes 166 formed in the bottom plate 162a of the shield case 162 and a flow passage in which the air is discharged toward the sheet member P from the discharge port 174e of the discharge duct 174. In other words, the flow of the air flowing through two flow passages is generated by the fan 176. In this way, parts are commonly used.

In addition, in the static elimination device 150, the air flowing through both end portions of the gap 180a is sucked into the suction duct 184 without flowing through the lower side of the corotron 160 (see FIG. 10). As a result, the air discharged to the sheet member P side through the corotron 160 is restrained from leaking to both sides in the depth direction.

In addition, in the static elimination device 150, the through-hole 166 through which air passes is formed in the bottom plate 162a of the shield case 162. As a result, the air flows from the corotron 160 toward the sheet member P with a simple configuration as compared with a case where the through-hole is not formed in the bottom plate of the shield case.

In addition, in the static elimination device 150, a flow passage area of the discharge duct 174 and an opening area of the through-holes 166 are determined such that the velocity of the air discharged from the discharge port 174e of the discharge duct 174 to the sheet member P side is faster than the velocity of the air flowing from the corotron 160 toward the sheet member P. As a result, the air discharged from the corotron 160 to the sheet member P side is restrained from flowing to the upstream side in the sheet transport direction as a compared with a case where the velocity of the air discharged from the discharge port 174e of the discharge duct 174 toward the sheet member P is slower than the velocity of the air flowing from the corotron 160 toward the sheet member P.

In addition, in the image forming apparatus 10, the air containing the ozone is restrained from stagnating in an inside of the apparatus body 10a is suppressed as compared with a case where the image forming apparatus 10 includes the static elimination device 250 according to the comparative exemplary embodiment.

### Second Exemplary Embodiment

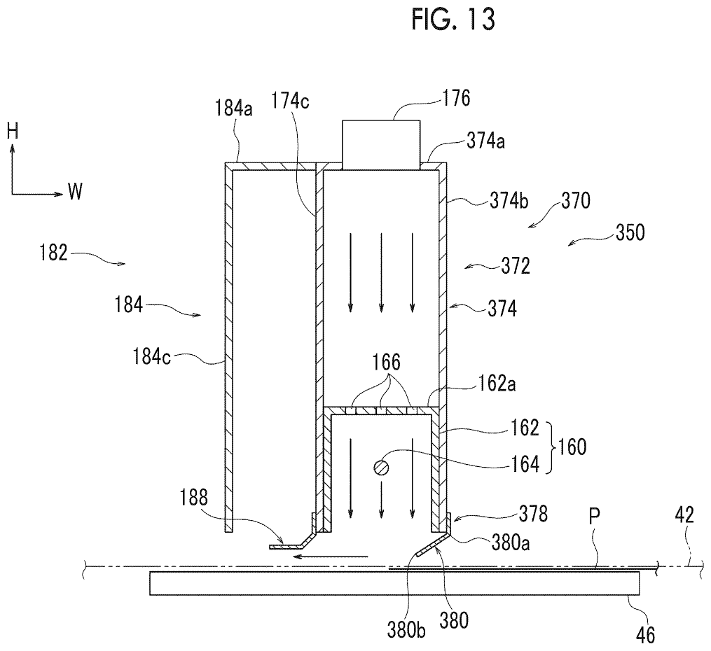

An example of a static elimination device and an image forming apparatus according to a second exemplary embodiment of the present disclosure will be described with reference to FIG. 13. The second exemplary embodiment will be described largely focusing on differences from the first exemplary embodiment.

### Configuration of Static Elimination Device 350

As shown in FIG. 13, a static elimination device 350 according to the second exemplary embodiment includes the corotron 160 that eliminates static electricity of the charged sheet member P through corona discharge, and a recovery unit 370 that recovers ozone generated through the corona discharge.

The recovery unit 370 includes a discharge portion 372 that discharges air toward the sheet member P being transported, through the inside of the corotron 160, and the suction portion 182 that sucks in the air discharged toward the sheet member P. The air is an example of a gas.

As shown in FIG. 13, the discharge portion 372 includes a discharge duct 374, and the fan 176 that causes air to flow (discharges air) toward the sheet member P being transported, through the discharge duct 374. Furthermore, the discharge portion 372 includes a guide member 378 attached to a lower end edge on the upstream side in the sheet transport direction in the discharge duct 374. The guide member 378 is an example of a restraining member.

The discharge duct 374 has a box shape that is open to the discharge path 42 side, and extends in the depth direction. The discharge duct 374 includes a ceiling plate 374a whose plate thickness direction is the up-down direction, a front plate 374b whose plate thickness direction is the width direction, and a back plate 174c whose plate thickness direction is the width direction and which is disposed on the downstream side of the front plate 374b in the sheet transport direction. Furthermore, the discharge duct 374 includes a pair of side plates (not shown) whose plate thickness direction is the depth direction. In addition, no gap is provided between the front plate 374b and the shield case 162.

The guide member 378 extends in the depth direction and has an L-shaped cross section. Specifically, a lower end portion 380 of the guide member 378 extends to the downstream side in the sheet transport direction, and an upstream end 380a of the lower end portion 380 in the sheet transport direction is located above a downstream end 380b of the lower end portion 380 in the sheet transport direction. As a result, the flow of the air containing the ozone, which is discharged to the sheet member P side, to the upstream side in the sheet transport direction is restrained.

### Effect of Static Elimination Device 350

In the static elimination device 350, as shown in FIG. 13, the operating fan 176 causes the air inside the discharge duct 374 to flow toward the sheet member P. The air flowing toward the sheet member P flows into the shield case 162 through the through-holes 166 formed in the bottom plate 162a of the shield case 162 and is discharged to the sheet member P side. In this way, the air containing the ozone generated through the corona discharge is discharged to the sheet member P side.

The air containing the ozone discharged to the sheet member P side is restrained from flowing to the upstream side in the sheet transport direction by the guide member 378, and flows to the downstream side in the sheet transport direction. Furthermore, the air that has flowed to the downstream side in the sheet transport direction is sucked into the suction duct 184 and is exhausted.

Although the specific exemplary embodiments of the present disclosure are described in detail, the exemplary embodiment of the present disclosure is not limited to such exemplary embodiments, and it is apparent to those skilled in the art that various other exemplary embodiments can be taken within the scope of the present disclosure. For example, in the above-described exemplary embodiment, the static elimination device 150, 350 is used in the image forming apparatus 10, but the static elimination device may be used in a post-processing device connected to the image forming apparatus.

In addition, in the above-described exemplary embodiment, the description has been made using the corotron 160, but any corona discharge electrode need only be used, such as a scorotron.

In addition, in the above-described exemplary embodiment, the air flows from the upstream side to the downstream side in the sheet transport direction along the sheet member P, but the air may flow from the downstream side to the upstream side. In this case, the effect produced by the fact that the air flows from the upstream side to the downstream side is not achieved.

In addition, in the above-described first exemplary embodiment, the air flowing toward the sheet member P by the operating fan 176 flows through the flow passage in which the air is discharged toward the sheet member P through the through-holes 166 formed in the bottom plate 162a of the shield case 162 and the flow passage in which the air is discharged toward the sheet member P from the discharge port 174e of the discharge duct 174. In other words, the flow of the air flowing through two flow passages is generated by the fan 176. However, a fan may be provided in each of the flow passages. In this case, the effect produced by the common use of the fans is not achieved.

(((1)))

A static elimination device comprising:
a corona discharge electrode that faces a recording medium to be transported and extends in a cross direction intersecting a transport direction of the recording medium;
an airflow generation device that causes a gas around the corona discharge electrode to flow toward the recording medium; and
a suction duct that is disposed on an upstream side or a downstream side of the corona discharge electrode in the transport direction, extends in the cross direction, and sucks in the gas flowing on the recording medium by the airflow generation device.
   (((2)))

The static elimination device according to (((1))),
wherein the suction duct is disposed on the downstream side of the corona discharge electrode in the transport direction, and
a restraining member that extends in the cross direction and restrains the gas flowing toward the recording medium from flowing on the upstream side of the corona discharge electrode in the transport direction is provided on the upstream side of the corona discharge electrode in the transport direction.
   (((3)))

The static elimination device according to (((2))),
wherein the restraining member includes a discharge duct that extends in the cross direction and discharges the gas toward the recording medium on the upstream side of the corona discharge electrode in the transport direction.
   (((4)))

The static elimination device according to (((3))),
wherein the airflow generation device discharges the gas from the discharge duct.
   (((5)))

The static elimination device according to (((3))) or (((4))),
wherein the discharge duct and the suction duct extend in the cross direction and protrude from the corona discharge electrode on both sides of the cross direction.
   (((6)))

The static elimination device according to any one of (((1))) to (((5))),
wherein the corona discharge electrode includes a shield case that is open toward the recording medium, extends in the cross direction, and has a box shape, and a discharge wire that is disposed inside the shield case and extends in the cross direction, and
a through-hole through which the gas flows due to a gas flow generated by the airflow generation device pass is formed in a bottom plate of the shield case.
   (((7)))

The static elimination device according to (((6))),
wherein the suction duct is disposed on the downstream side of the corona discharge electrode in the transport direction,
a discharge duct that extends in the cross direction and discharges the gas toward the recording medium on the upstream side of the corona discharge electrode in the transport direction by the gas flow generated by the airflow generation device is provided, and
a flow passage area of the discharge duct and an opening area of the through-hole are determined such that a velocity of the gas discharged from the discharge duct to the upstream side of the corona discharge electrode is faster than a velocity of the gas from the corona discharge electrode toward the recording medium.
   (((8)))

An image forming apparatus comprising:
a transport section that transports a recording medium;
an image forming section that forms an image on the recording medium transported by the transport section; and
the static elimination device according to any one of (((1))) to (((7))), which eliminates static electricity of the charged recording medium on which the image is formed and which is transported.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A static elimination device comprising:
a corona discharge electrode that faces a recording medium to be transported and extends in a cross direction intersecting a transport direction of the recording medium;
an airflow generation device that causes a gas around the corona discharge electrode to flow toward the recording medium; and
a suction duct that is disposed on an upstream side or a downstream side of the corona discharge electrode in the transport direction, extends in the cross direction, and sucks in the gas flowing on the recording medium by the airflow generation device.

2. The static elimination device according to claim 1,
wherein the suction duct is disposed on the downstream side of the corona discharge electrode in the transport direction, and
a restraining member that extends in the cross direction and restrains the gas flowing toward the recording medium from flowing on the upstream side of the corona discharge electrode in the transport direction is provided on the upstream side of the corona discharge electrode in the transport direction.

3. The static elimination device according to claim 2,
wherein the restraining member includes a discharge duct that extends in the cross direction and discharges the gas toward the recording medium on the upstream side of the corona discharge electrode in the transport direction.

4. The static elimination device according to claim 3,
wherein the airflow generation device discharges the gas from the discharge duct.

5. The static elimination device according to claim 3,
wherein the discharge duct and the suction duct extend in the cross direction and protrude from the corona discharge electrode on both sides of the cross direction.

6. The static elimination device according to claim 4,
wherein the discharge duct and the suction duct extend in the cross direction and protrude from the corona discharge electrode on both sides of the cross direction.

7. The static elimination device according to claim 1,
wherein the corona discharge electrode includes a shield case that is open toward the recording medium, extends in the cross direction, and has a box shape, and a discharge wire that is disposed inside the shield case and extends in the cross direction, and
a through-hole through which the gas flows due to a gas flow generated by the airflow generation device pass is formed in a bottom plate of the shield case.

8. The static elimination device according to claim 7,
wherein the suction duct is disposed on the downstream side of the corona discharge electrode in the transport direction,
a discharge duct that extends in the cross direction and discharges the gas toward the recording medium on the upstream side of the corona discharge electrode in the transport direction by the gas flow generated by the airflow generation device is provided, and
a flow passage area of the discharge duct and an opening area of the through-hole are determined such that a velocity of the gas discharged from the discharge duct to the upstream side of the corona discharge electrode is faster than a velocity of the gas from the corona discharge electrode toward the recording medium.

9. An image forming apparatus comprising:
a transport section that transports a recording medium;
an image forming section that forms an image on the recording medium transported by the transport section; and
the static elimination device according to claim 1, which eliminates static electricity of the charged recording medium on which the image is formed and which is transported.

10. An image forming apparatus comprising:
a transport section that transports a recording medium;
an image forming section that forms an image on the recording medium transported by the transport section; and
the static elimination device according to claim 2, which eliminates static electricity of the charged recording medium on which the image is formed and which is transported.

11. An image forming apparatus comprising:
a transport section that transports a recording medium;
an image forming section that forms an image on the recording medium transported by the transport section; and
the static elimination device according to claim 3, which eliminates static electricity of the charged recording medium on which the image is formed and which is transported.

12. An image forming apparatus comprising:
a transport section that transports a recording medium;
an image forming section that forms an image on the recording medium transported by the transport section; and
the static elimination device according to claim 4, which eliminates static electricity of the charged recording medium on which the image is formed and which is transported.

13. An image forming apparatus comprising:
a transport section that transports a recording medium;
an image forming section that forms an image on the recording medium transported by the transport section; and
the static elimination device according to claim 5, which eliminates static electricity of the charged recording medium on which the image is formed and which is transported.

14. An image forming apparatus comprising:
a transport section that transports a recording medium;
an image forming section that forms an image on the recording medium transported by the transport section; and
the static elimination device according to claim 6, which eliminates static electricity of the charged recording medium on which the image is formed and which is transported.

15. An image forming apparatus comprising:
a transport section that transports a recording medium;
an image forming section that forms an image on the recording medium transported by the transport section; and
the static elimination device according to claim 7, which eliminates static electricity of the charged recording medium on which the image is formed and which is transported.

16. An image forming apparatus comprising:
a transport section that transports a recording medium;
an image forming section that forms an image on the recording medium transported by the transport section; and
the static elimination device according to claim 8, which eliminates static electricity of the charged recording medium on which the image is formed and which is transported.
